(19) United States
(12) Patent Application Publication
(10) Pub. No.: US 2010/0009668 A1
(43) Pub. Date: Jan. 14, 2010

(54) SYSTEM AND METHOD FOR CUSTOMIZING FUNCTIONS OF A MOBILE PHONE

(75) Inventor: CHAO-WEI WANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/436,116

(22) Filed: May 5, 2009

(30) Foreign Application Priority Data
Jul. 11, 2008 (CN) 200810302701.5

(51) Int. Cl. H04M 3/00; H04M 1/00

(52) U.S. Cl. 455/418; 455/558

(57) ABSTRACT

A system and method for customizing functions of a mobile phone provides different operation modes for different users of the mobile phone. The system and method further provides different function features under the different operation modes.

### BACKGROUND

1. Technical Field

Embodiments of the present disclosure relate to systems and methods for designing functions of a mobile phone, and more particularly to a system and method for customizing functions of a mobile phone.

2. Description of Related Art

At present, most mobile phones only provide a single operation mode. This single operation mode often provides many functions to users. Some of these functions may be complicated and embedded inside many menus causing frustration to an end user of a mobile phone. As a result, many of these functions often are unexplored and unused by the end user.

Therefore, an effective system and method for customizing functions of a mobile phone is desired to overcome the above-described shortcomings.

### BRIEF DESCRIPTION OF THE DRAWINGS

FIG. 1 is a block diagram of one embodiment of a system for customizing functions of a mobile phone.

FIG. 2 is a flowchart of one embodiment of a method for customizing functions of a mobile phone.

FIG. 3 is a flowchart of one embodiment of a method of customizing functions of a mobile phone when a new SIM card is connected to the mobile phone.

### DETAILED DESCRIPTION

All of the processes described below may be embodied in, and fully automated via, functional modules executed by one or more general purpose processors. The functional modules may be stored in any type of computer-readable medium or other computer storage device. Some or all of the methods may alternatively be embodied in specialized computer hardware or communication apparatus.

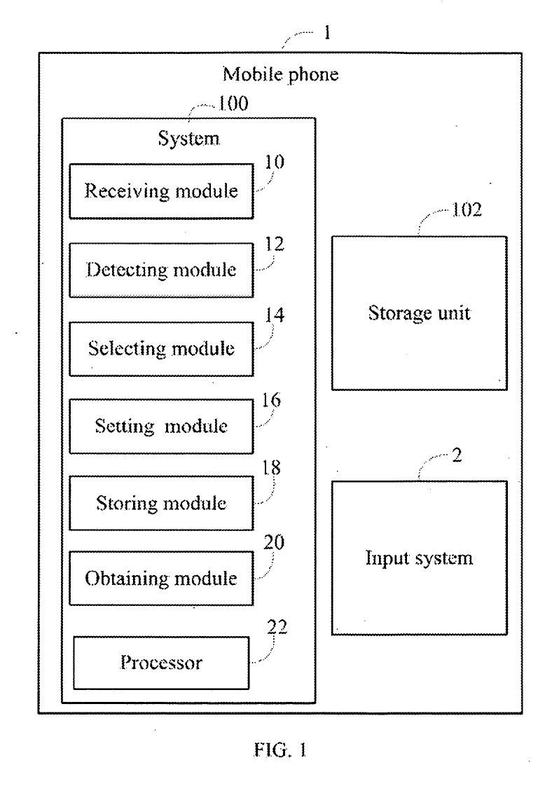

FIG. 1 is a block diagram of one embodiment of a system 100 for customizing functions of a mobile phone 1. In one embodiment, the mobile phone 1 includes a storage unit 102 and an input system 2. The input system 2 may be a keypad or a touch screen. The storage unit 102 stores many kinds of data, such as a customization function code of the mobile phone 1, computerized codes of the system 100, programs of an operating system and other applications of the mobile phone 1. The mobile phone 1 is installed with at least one subscriber identity module (SIM) card. Each of the at least one SIM card corresponds to an international mobile subscriber identification number (IMSI).

In one embodiment, the system 100 includes a receiving module 10, a detecting module 12, a selecting module 14, a setting module 16, a storing module 18, and an obtaining module 20. One or more specialized or general purpose processors, such as a processor 22 executes the computerized codes of the functional modules 10-20 to perform certain customizing functions of the mobile phone 1.

The receiving module 10 receives an customization function code input by a user via the input system 2.

The detecting module 12 checks if the received customization function code matches the stored code in the storage unit 102. If the received customization function code is different from the customization function code stored in the storage unit 102, the system 100 cannot start up.

The selecting module 14 provides menu options of various operation modes of the mobile phone 1. The user may select a desired operation mode of the mobile phone 1 if the received customization function code is the same as the customization function code stored in the storage unit 102. In one embodiment, the operation modes include an identity (ID) user mode, a default user mode, and a user configuration mode. In one embodiment, the ID user mode has more functions enabled than the default user mode has. In another embodiment, functions of the ID user mode may be more complicated, and functions of the default user mode may be more simple. For example, the ID user mode may comprise setting network settings of the mobile phone 1, while the default user mode may comprise changing a wallpaper of the mobile phone 1. If the SIM card is a new SIM card (newly connected to the mobile phone for the first time), the mobile phone enters the default user mode. If the SIM card is a recognized SIM card (previously connected to the mobile phone for the first time), the mobile phone 1 can enter anyone of the operation modes provided. The user configuration mode is for the user who uses the recognized SIM card to modify the customization function code stored in the storage unit 102.

The setting module 16 sets function features under the ID user mode or under the default user mode if the ID user mode is selected or if the default user mode is selected, respectively. For example, the mobile phone 1 may include a camera function and a music player function. If the ID user mode is selected and the setting module 16 sets the camera function as being disabled and the music player function as being enabled, the user cannot use the camera function but can use the music player function under the ID user mode.

The storing module 18 stores the set function features of the selected operation mode to the storage unit 102.

The obtaining module 20 reads the IMSI of the SIM card connected to the mobile phone 1 if the ID user mode is selected. The storing module 18 also stores the IMSI of the SIM card in the storage unit 102.

The setting module 16 also sets a new customization function code if the user configuration mode is selected. The storing module 18 is further able to update the customization function code stored in the storage unit 102 with the new customization function code.

The setting module 16 further provides a prompt to the user to restart the mobile phone 1 to enable the set function features and the new customization function code.

The detecting module 12 also detects if the IMSI of the SIM card exists in the storage unit 102 when a new SIM card is connected to the mobile phone 1. The mobile phone 1 enters the ID user mode if the IMSI of the new SIM card exists in the storage unit 102, or enters the default user mode if the IMSI does not exist in the storage unit 102.

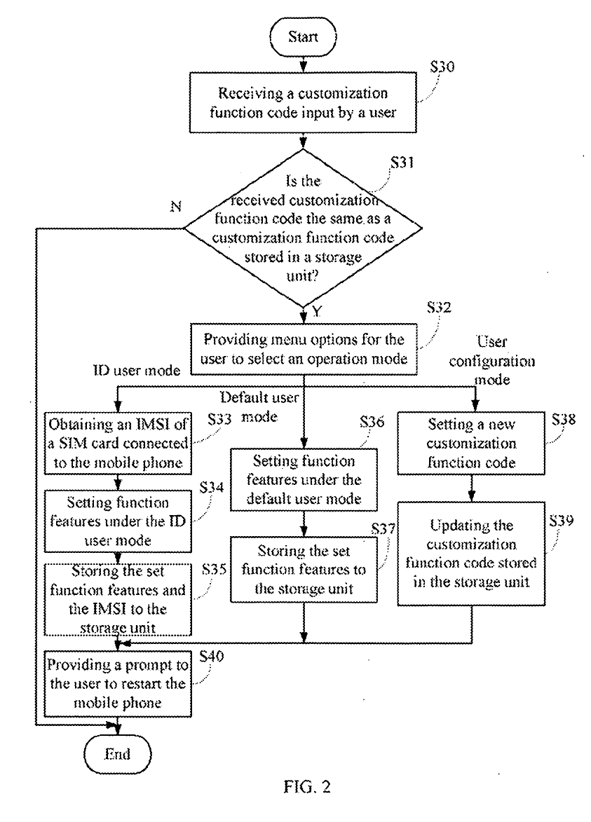

FIG. 2 is a flowchart of one embodiment of a method for customizing functions of the mobile phone 1. Depending on the embodiment, additional blocks may be added, others removed, and the ordering of the blocks may be changed.

In block S30, the receiving module 10 receives a customization function code input by a user via the input system 2.

In block S31, the detecting module 12 checks if the received customization function code is the same as the customization function code stored in the storage unit 102. If the received customization function code is different from the customization function code stored in the storage unit 102, the system 100 is disabled and the procedure ends.

If the received customization function code is the same as the customization function code stored in the storage unit 102, in block S32, the selecting module 14 provides menu options of operation modes for the user to select an operation mode of the mobile phone 1. The operation modes include an ID user mode, a default user mode, and a user configuration mode.

If the ID user mode is selected, in block S33, the obtaining module 20 reads the IMSI of the SIM card connected to the mobile phone 1. In block S34, the setting module 16 sets the function features under the ID user mode. In block S35, the storing module 18 stores the set function features and the IMSI to the storage unit 102. The procedure goes to block S40, the setting module 16 provides a prompt to the user to restart the mobile phone 1 to enable the set function features.

If the default user mode is selected, in block S36, the setting module 16 sets the function features under the default user mode. In block S37, the storing module 18 stores the set function features to the storage unit 102. The procedure goes to the block S40 to enable the set function features.

If the user configuration mode is selected, in block S38, the setting module 16 sets a new customization function code. In block S39, the storing module 18 updates the customization function code stored in the storage unit 102 with the new customization function code. The procedure goes to the block S40 to enable the new customization function code.

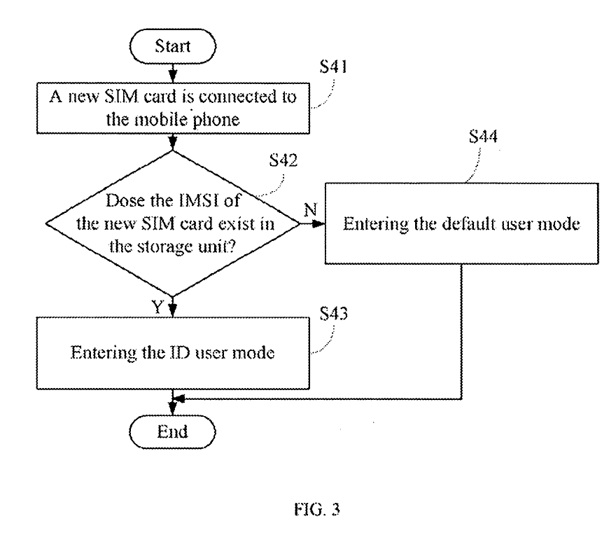

FIG. 3 is a flowchart of one embodiment of a method of customizing functions of the mobile phone 1 when a new SIM card is connected to the mobile phone. Depending on the embodiment, additional blocks may be added, others removed, and the ordering of the blocks may be changed.

In block S41, a new SIM card is connected to the mobile phone 1.

In block S42, the detecting module 12 detects if the IMSI of the new SIM card exists in the storage unit 102.

If the IMSI of the new SIM card exists in the storage unit 102, in block S43, the mobile phone 1 enters the ID user mode. If the IMSI of the new SIM card does not exist in the storage unit 102, in block S44, the mobile phone 1 enters the default user mode.

The above embodiments provide multiple operation modes in the mobile phone 1, these operation modes can provide different functions, so as to satisfy users with different demands of the mobile phone 1. Because the IMSI of a new SIM card does not exist in the storage unit 102 of the mobile phone and is not to be stored in the storage unit 102, the present disclosure also prevents an unauthorized user who uses the new SIM card connected to the mobile phone 1 to use the functions of the mobile phone 1.

Although certain inventive embodiments of the present disclosure have been specifically described, the present disclosure is not to be construed as being limited thereto. Various changes or modifications may be made to the present disclosure without departing from the scope and spirit of the present disclosure.

1. A system for customizing functions of a mobile phone, the system comprising:
a storage unit;
at least one processor; and
one or more programs stored in the storage unit and being executable by the at least one processor, the one or more programs comprising:
a receiving module to receive a customization function code input by a user via an input system of the mobile phone;
a selecting module to provide menu options for the user to select an operation mode of the mobile phone if the received customization function code is the same as a customization function code stored in a storage unit of the mobile phone;
a setting module to set function features of each of the menu options under the operation mode;
a storing module to store the set function features of each of the menu options in the storage unit; and
the setting module further to provide a prompt to the user to restart the mobile phone to enable the set function features of the mobile phone.

2. The system of claim 1, wherein the operation mode is selected from the group of an identity (ID) user mode, a default user mode, and a user configuration mode.

3. The system of claim 2, wherein the setting module is further to set a new customization function code if the user configuration mode is selected.

4. The system of claim 3, wherein the storing module is further to update the customization function code stored in the storage unit with the new customization function code.

5. The system of claim 2, further comprising:
an obtaining module to read an international mobile subscriber identification number (IMSI) of a subscriber identity module (SIM) card installed in the mobile phone if the ID user mode is selected.

6. The system of claim 5, wherein the storing module is further to store the IMSI of the SIM card into the storage unit.

7. The system of claim 5, further comprising:
a detecting module to detect if an IMSI of a new SIM card exists in the storage unit when a new SIM card connected to the mobile phone; and
the mobile phone enters the ID user mode if the IMSI of the new SIM card exists in the storage unit, or enters the default user mode if the IMSI does not exist in the storage unit.

8. A method for customizing functions of a mobile phone, the method comprising:
receiving a customization function code input by a user via an input system of the mobile phone;
providing menu options for the user to select an operation mode of the mobile phone if the received customization function code is the same as a customization function code stored in a storage unit of the mobile phone;
setting function features of each of the menu options under the operation mode;
storing the set function features of each of the menu options in the storage unit; and
providing a prompt to the user to restart the mobile phone to enable the set function features of the mobile phone.

9. The method of claim 8, wherein the operation mode is selected from the group of an identity (ID) user mode, a default user mode, and a user configuration mode.

10. The method of claim 9, further comprising:
setting a new customization function code if user configuration mode is selected; and
updating the customization function code stored in the storage unit with the new customization function code.

11. The method of claim 9, further comprising:
reading an international mobile subscriber identification number (IMSI) of a subscriber identity module (SIM) card connected to the mobile phone if the ID user mode is selected; and
storing the IMSI of the SIM card to the storage unit.

12. The method of claim 11, further comprising:
detecting if the IMSI of a new SIM card exists in the storage unit when the new SIM card connected to the mobile phone;
entering the ID user mode if the IMSI of the new SIM card exists in the storage unit, or entering the default user mode if the IMSI does not exist in the storage unit.

13. A computer-readable medium having stored therein instructions that, when executed by a mobile phone, cause the mobile phone to perform a method for customizing functions of a mobile phone, the method comprising:
receiving a customization function code input by a user via an input system of the mobile phone;
providing menu options for the user to select an operation mode of the mobile phone if the received customization function code is the same as a customization function code stored in a storage unit of the mobile phone;
setting function features of each of the menu options under the operation mode;
storing the set function features of each of the menu options in the storage unit; and
providing a prompt to the user to restart the mobile phone to enable the set function features of the mobile phone.

14. The medium of claim 13, wherein the operation mode is selected from the group of an identity (ID) user mode, a default user mode, and a user configuration mode.

15. The medium of claim 14, further comprising:
setting a new customization function code if the user configuration mode is selected; and
updating the customization function code stored in the storage unit with the new customization function code.

16. The medium of claim 14, further comprising:
reading an international mobile subscriber identification number (IMSI) of a subscriber identity module (SIM) card connected to the mobile phone if the ID user mode is selected; and
storing the IMSI of the SIM card to the storage unit.

17. The medium of claim 16, further comprising:
detecting if the IMSI of a new SIM card exists in the storage unit when the new SIM card connected to the mobile phone;
entering the ID user mode if the IMSI of the new SIM card exists in the storage unit, or entering the default user mode if the IMSI does not exist in the storage unit.
